(19) United States
(12) Patent Application Publication
(10) Pub. No.: US 2007/0050179 A1
(43) Pub. Date: Mar. 1, 2007

(54) DISPERSION MODELING

(75) Inventor: Steven Mark Probst, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Sage Environmental Consulting Inc., Austin, TX (US)

(21) Appl. No.: 11/465,001

(22) Filed: Aug. 16, 2006

Related U.S. Application Data
(60) Provisional application No. 60/710,885, filed on Aug. 24, 2005.

(51) Int. Cl. G06G 7/48

(52) U.S. Cl. 703/2; 703/6

(57) ABSTRACT

Presented are methods carried out by presenting a user interface to a user where the interface is maintained by a host remote to the user; receiving user data inputs including emissions data at a storage module remote to the user via the user interface; executing dispersion modeling based at least in part on the emissions data via a transaction module coupled to the host; storing user data inputs and dispersion modeling outputs so that the inputs and outputs are available for retrieval and use in subsequent dispersion modeling runs. Also presented are systems including a user interface through which users may interact with a host including creating and maintaining a user account, inputting user data, and requesting dispersion modeling; a host that maintains user data and that is coupled to a transaction module; a storage module coupled to a transaction module, the storage module stores user data including emissions data and output modeling data related to multiple modeling runs; a transaction module that processes user data including modeling dispersion data.

### CROSS-REFERENCE TO RELATED APPLICATIONS

This non-provisional application claims priority based upon prior U.S. Provisional Patent Application Ser. No. 60/710,885 filed Aug. 24, 2005 in the name of Steven Mark Probst, entitled “Remote Air Modeling,” the disclosure of which is incorporated herein by reference.

### BACKGROUND OF THE INVENTION

This invention relates generally to mathematical modeling, and particularly to a web-based tool for modeling dispersion of emissions in air.

Regulatory bodies, such as the Environmental Protection Agency (EPA), regulate emission sources of a variety of contaminants. In particular, in 40 C.F.R. 51 the EPA provides a “Guideline on Air Quality Models” (the “Guideline”) that establishes standardized models for regulated emission sources to use when modeling dispersion of emissions, such as for purposes of applying for and receiving permits to operate. The EPA periodically updates the preferred air dispersion models described in the Guideline. Recently the EPA established the AMS/EPA Regulatory Model (AERMOD) to replace the Industrial Source Complex (ISC) model as the preferred air dispersion model in the Guide.

To date, tools/models available commercially that incorporate ISC and AERMOD standards are cumbersome in that, for example, the models require re-entry of large amounts of data each time a run of the model is carried out; the models are expensive in that they are generally run locally at a user's computer, and charges for the model are assessed for each user running the model. Additionally, large amounts of data are often processed in a modeling run and processing speed and capacity may be limited by the processing capacity of a user's personal computer.

Thus, a need persists for dispersion modeling tools that lower costs, increase processing capacity, and store data that can be re-used in future modeling runs.

### BRIEF SUMMARY OF THE INVENTION

Provided are dispersion modeling methods carried out by presenting a user interface to a user where the interface is maintained by a host remote to the user; receiving user data inputs including emissions data at a storage module remote to the user via the user interface; executing dispersion modeling based at least in part on the emissions data via a transaction module coupled to the host; storing user data inputs and dispersion modeling outputs so that the inputs and outputs are available for retrieval and use in subsequent dispersion modeling runs.

Also provided are dispersion modeling systems including a user interface through which users may interact with a host including creating and maintaining a user account, inputting user data, and requesting dispersion modeling; a host that maintains user data and that is coupled to a transaction module; a storage module coupled to a transaction module, the storage module stores user data including emissions data and output modeling data related to multiple modeling runs; a transaction module that processes user data including modeling dispersion data.

### BRIEF DESCRIPTION OF THE DRAWINGS

FIG. 1 is a block diagram representing a system in accordance with embodiments of the present invention.

FIG. 2 is an illustration of a web page for registering a user in accordance with embodiments of the present invention.

FIG. 3 is an illustration of a web page for confirming account information associated with a user in accordance with embodiments of the present invention.

FIG. 4 is an illustration of a web page for submitting an air modeling job in accordance with embodiments of the present invention.

FIG. 5 is an illustration of a web page for viewing the status of dispersion modeling jobs in accordance with embodiments of the present invention.

FIG. 6 is an illustration of a web page for viewing job output details in accordance with embodiments of the present invention.

FIG. 7 is a block diagram illustrating a web server and executable server in accordance with embodiments of the present invention.

FIG. 8 is a flow chart illustrating methods of dispersion modeling in accordance with embodiments of the present invention.

### DETAILED DESCRIPTION

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first component couples to a second component, that connection may be through a direct connection, or through an indirect connection via other devices and connections. It is further noted that all functions described herein may be performed in either hardware or software, or a combination thereof, unless indicated otherwise.

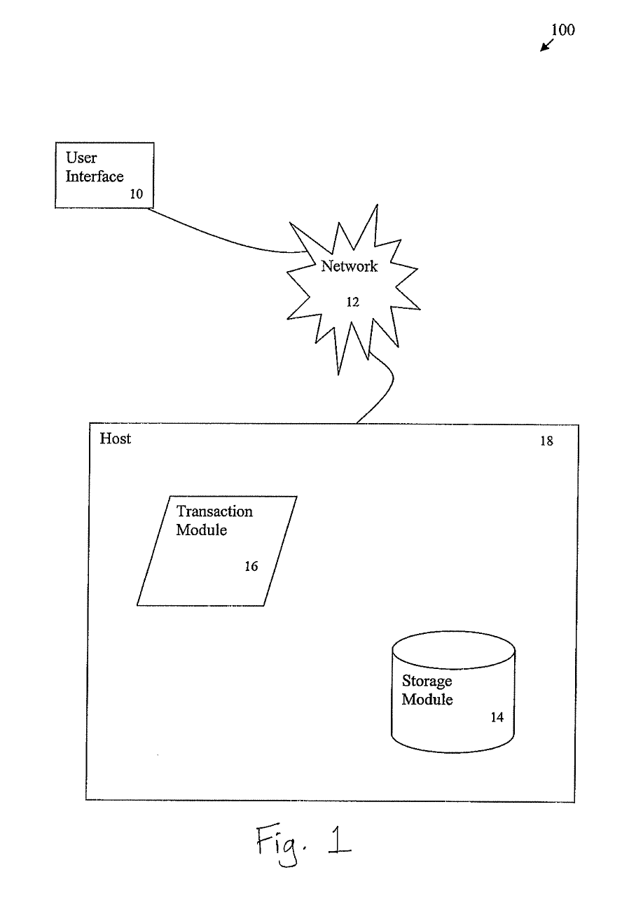

In accordance with various embodiments of the present invention, FIG. 1 is a block diagram of a system 100 for carrying out dispersion modeling. The system includes a user interface 10, such as a web page or web portal, through which a user may interact with a host 18. When interacting with the host 18, a network 12, or multiple networks coupled together, may provide the connection between the user and host 18. In this embodiment the transaction module 16 and storage module 14 are housed by the host 18. Alternatively, the host 18, transaction module 16, and storage module 14 may be at different locations from each other. The host 18, transaction module 16, and storage module 14 are coupled together in order to meet the needs of the user.

Methods in accordance with various embodiments of the present invention may also be described in reference to the system 100 of FIG. 1. Such methods may be carried out by presenting a user interface 10 to a user where the interface 10 is maintained by a host 18 that is remote to the user. User data inputs, such as emissions data, can be made via the user interface 10 and are received at a storage module 14 that is remote to the user. The transaction module 16 executes dispersion modeling based at least in part on the emissions data. The data inputs and dispersion modeling outputs are stored in the storage module 14 such that the inputs and outputs are available for retrieval and use by the user in subsequent dispersion modeling runs.

In some embodiments the host is a vendor that offers dispersion modeling services via the internet. The dispersion modeling system may include a web site as a user interface, through which users can register and create accounts with the host. Additionally, the host maintains a storage module that stores user data and a transaction module that carries out dispersion modeling based at least in part on emissions data provided by a user. Thus, a plurality of users may create accounts with the host and carry out dispersion modeling remotely via the web-based modeling system utilizing the storage module and transaction module capacity of the host.

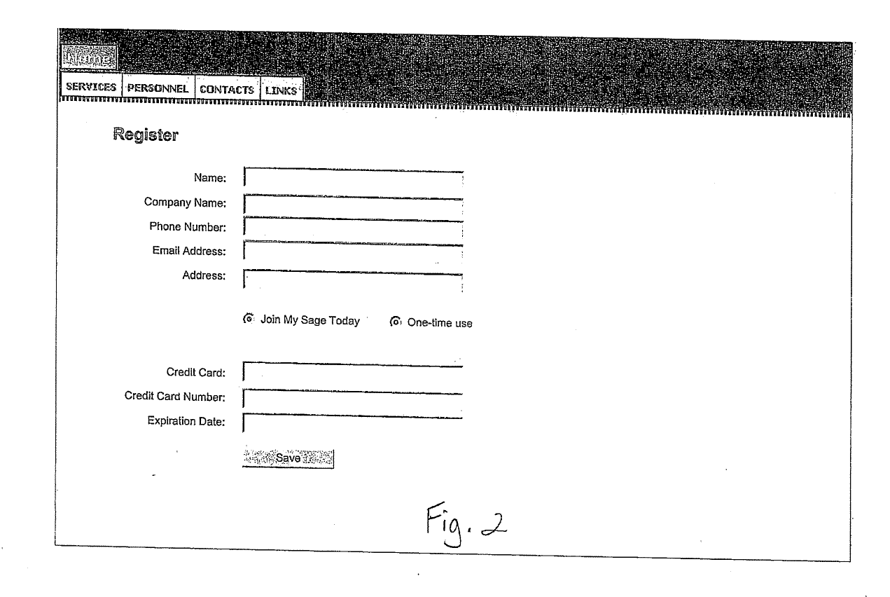

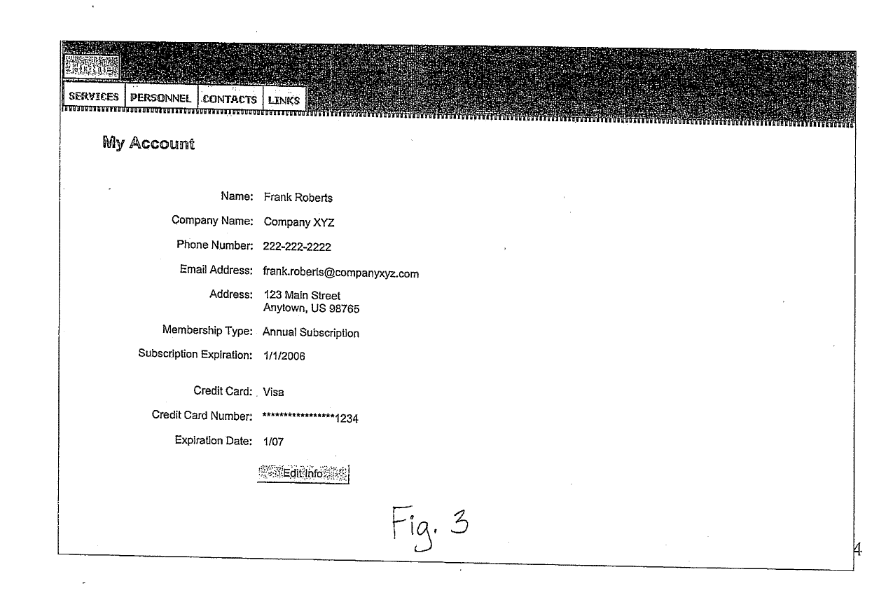

In addition to allowing registration and access to the dispersion modeling system, the user interface allows users to submit jobs, view the status of jobs, upload input files, and download output files reflecting the results of dispersion modeling runs. FIG. 2 is an example of a registration page on a web site requesting user information needed to create a user account. FIG. 3 is an example of a web page confirming a user's account information, such as company name, credit card information, contact information, etc.

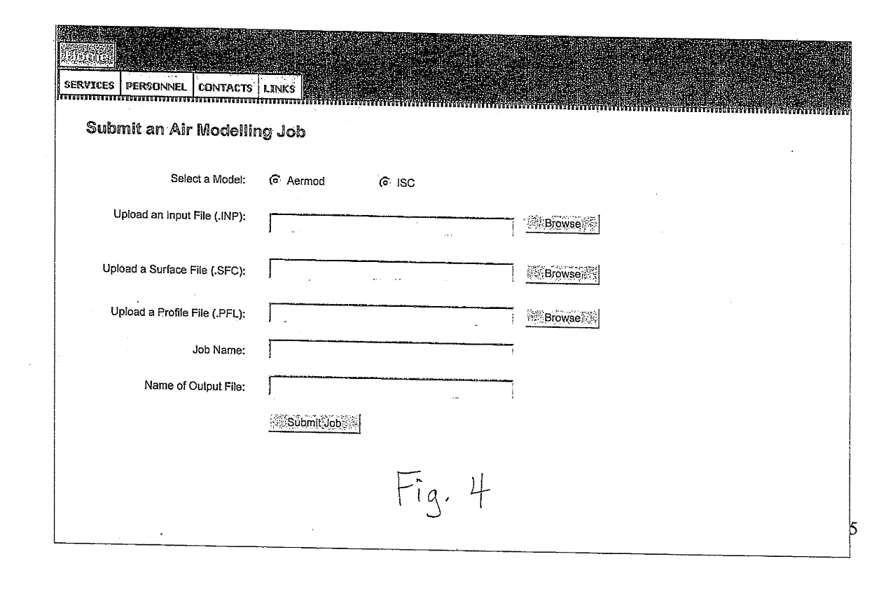

FIG. 4 is an example of a web page where dispersion modeling jobs might be submitted to a host. Such a web page or series of web pages may take the form of a “Submit a Job Wizard”. A user may specify the type of dispersion modeling job to run, such as AERMOD versus ISC, in addition to uploading files reflecting various types of pertinent data, such as emissions data. Further, the user selects a name for the modeling run and a name for the output file that will carry the dispersion modeling results upon completion of the run.

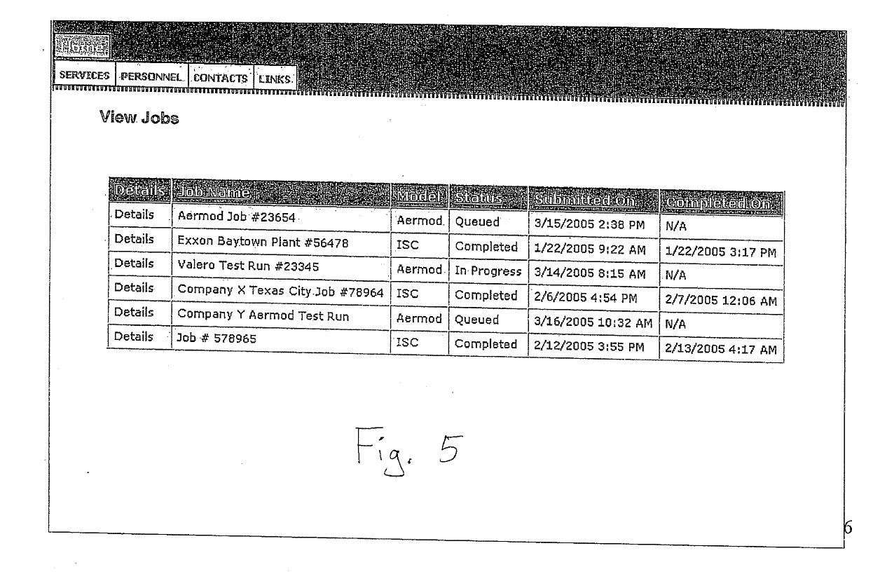

FIG. 5 is an example of a web page showing the status of multiple jobs submitted by a user. The user may differentiate among jobs by reference to a descriptive job name as well as the type of model selected for the run (e.g.—AERMOD versus ISC). The status of the job is displayed as “Queued”, “Completed”, “Ready for Execution”, or “In Progress”, along with the date and time the job was submitted and completed.

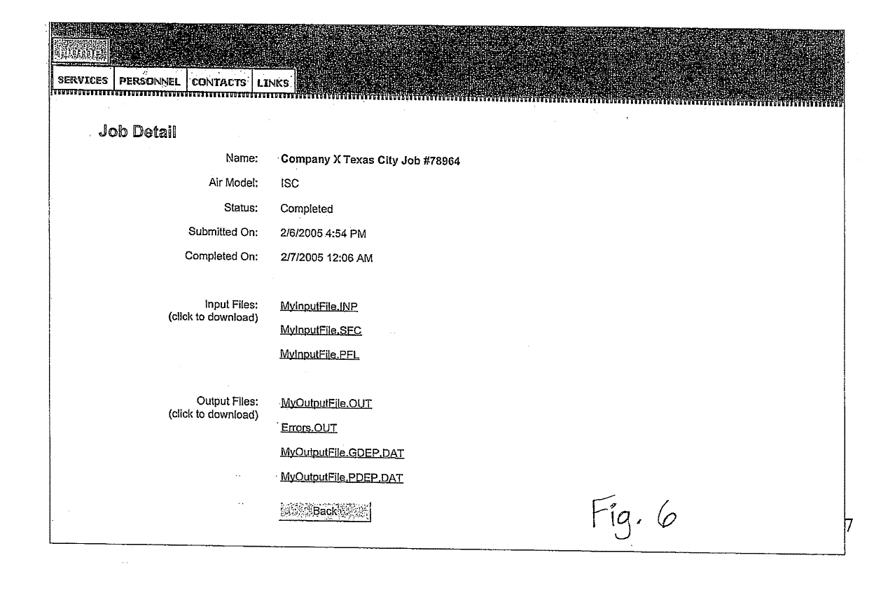

FIG. 6 is an example of a web page showing job output details after completion of dispersion modeling job. In addition to the information identifying the job (job name, model type, timing data, etc.), the job output details may give the user access to the input data and output data for the run. The user may, thus, conveniently download the output data files from the web page for viewing or optional local storage at the user location, in addition to storage on the storage module of the dispersion modeling system.

The storage module stores user data inputs including user identifying information and data relevant to dispersion modeling. Additionally, the storage module stores dispersion modeling outputs such that a catalog of modeling data may be accumulated for reference/reuse by the user. Such catalogued historical data may later be searched and retrieved from the database as desired. Additionally, output analysis tools may be available to assist the user in analyzing output data.

The transaction module carries out dispersion modeling for a user based on a model maintained by the host and data input by the user. Non-limiting examples of input parameters and data supplied by the user in order to carry out dispersion modeling include facility and building information, release parameter information, emission rates (even for multiple pollutants), control parameters, land use data, terrain data, and meteorological data. Depending on the availability of processing capacity, the transaction module may also queue dispersion modeling jobs. In some embodiments, the transaction module includes a bank of servers, such as Fortran servers, available depending upon the number and size, even for multi-pollutant runs, of the dispersion modeling jobs requested at any one time. Additional optimization options may include parallel processing.

In various embodiments, a plurality of independent users with emissions concerns may create accounts with the host by registering and providing user specific information via a web site hosted by the host, including a storage module and transaction module. Each user may have its own account with the host.

User account information is stored in a storage module provided by the host. Additionally, each user may input data to its account that is relevant to dispersion modeling. Such data, such as emissions data, is also stored in the storage module, associated with the user's account, and maintained and updated by the user as desired.

The host maintains the transaction module, which upon the request of a user via the web site may carry out dispersion modeling based on the user's data inputs. In various embodiments, the transaction module carries out dispersion modeling according to the Federal “Guidelines on Air Quality Models” as described in 40 C.F.R. 51. Examples of such dispersion modeling are the AMS/EPA Regulatory Model (AERMOD) and Industrial Source Complex (ISC) model.

Typically users create an account and input data relevant for dispersion modeling according to the AERMOD or ISC models in order to comply with requirements to receive permits. Thus, in order to periodically renew a permit or receive a permit under new emission conditions, additional modeling runs may be required. The storage module of the dispersion modeling system stores dispersion modeling output data such that a user does not have to input the same data over and over each time an additional dispersion modeling run is needed. Rather, relevant historical data that is stored and remains constant may be reused, in addition to new data that may be relevant to reflect a change in conditions at the emission source.

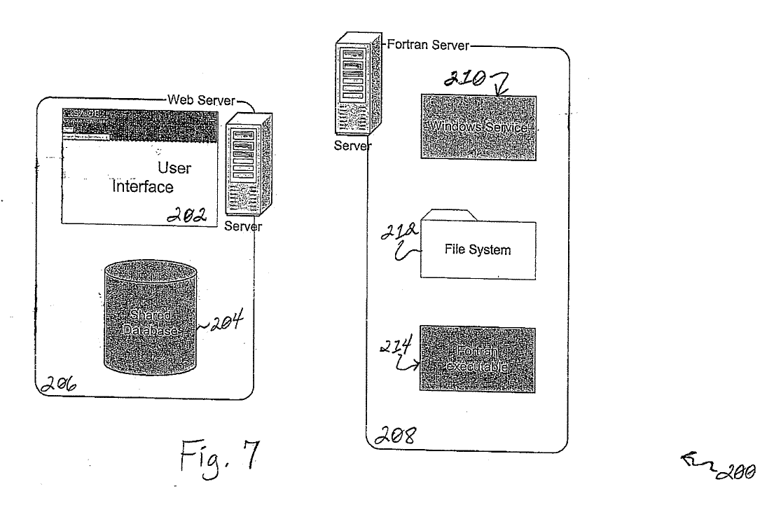

FIG. 7 shows another embodiment of a dispersion modeling system 200 in accordance with embodiments of the invention. A user interface 202 and storage module (or “shared database”) 204 are elements of a web server 206. The web server 206 is coupled to a transaction module 208 that in these embodiments is a Fortran server. The Fortran server/transaction module 208 includes a Windows service 210, file system 212, and Fortran executable 214 element.

The user interface 202 allows users to submit dispersion modeling jobs; view the status of dispersion modeling jobs; upload emission and condition data input files; download dispersion modeling data output files; and register/create an account within the host's dispersion modeling system. The shared database 204 stores user information, as well as dispersion modeling inputs and outputs.

The Windows service 210 in the Fortran server 208 queues dispersion modeling jobs and manages the Fortran executable 214 that runs modeling jobs.

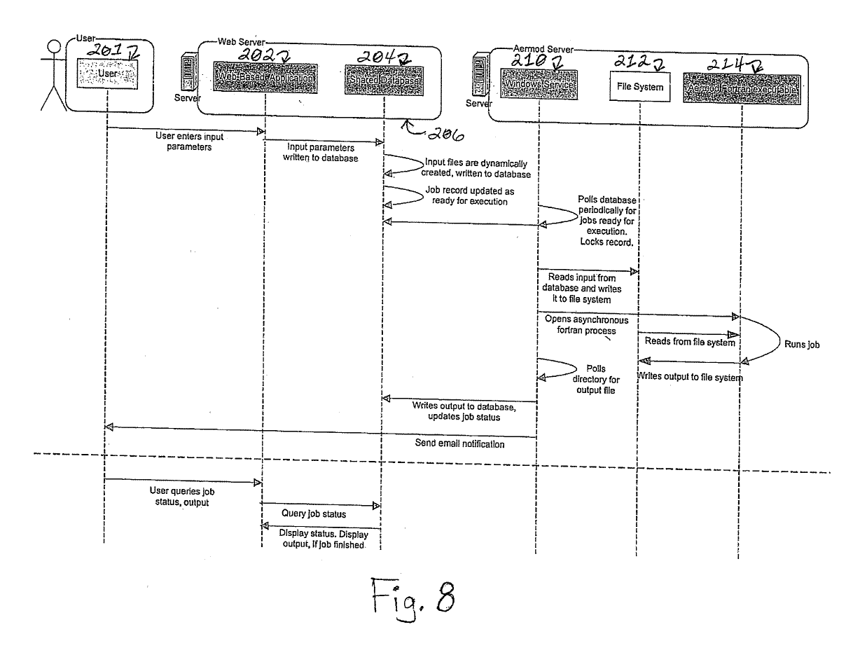

FIG. 8 is a graphic illustration of methods of dispersion modeling in accordance with embodiments of the present invention. The elements of the dispersion modeling system in FIG. 8 that carry out the methods are similar to the dispersion modeling system elements in FIG. 7. The method illustrated by FIG. 8 may be carried out by a user 201 entering input parameters to a web based application 202, such as a web page/user interface, on a web server. Such input parameters may include information specific for identifying the user and the particular run initiated by the user, in addition to emissions and other data relevant to dispersion modeling. The web based application 202 writes the input parameters to the database 204. One or more files are created for the input parameters in the database 204 and the dispersion modeling job associated with the input parameters is queued for execution.

The Windows service 210 periodically polls the database 204 for jobs that are ready for execution. When the system is ready to execute the next dispersion modeling job, the windows service 210 reads the input file from the database 204 and writes the input file to the file system 212. The Windows service 210 further summons the Fortran model from the Fortran executable 214 element, which reads the input from the file system 212, runs the dispersion modeling job, and writes the dispersion modeling output to the file system 212. Finally, the Windows service 210 polls the file system 212 for the output from the executable 214, writes the output to the database 204, updates the status of the job, and sends an e-mail notification to the user 201 that the job submitted is complete. During the course of the time while the job is in the queue and then processed, the user 201 may query the job status via the web-based application 202 to the database 204, which displays the status of the job, including an output file if the job is complete, via the web-based application 202.

Although exemplary embodiments of the invention have been disclosed, it will be apparent to those skilled in the art that various changes and modifications can be made which will achieve some of the advantages of the invention without departing from the spirit and scope of the invention. For example, it will be obvious to those reasonably skilled in the art that, although the description was primarily directed to a particular hardware system and operating system, other hardware and operating systems could be used in the same manner as that described. Other aspects, such as the specific instructions utilized to achieve a particular function, as well as other modifications to the inventive concept are intended to be covered by the appended claims.

What is claimed is:

1. A method comprising:
presenting a user interface to a user where the interface is maintained by a host remote to the user;
receiving user data inputs including emissions data at a storage module remote to the user via the user interface;
executing dispersion modeling based at least in part on the emissions data via a transaction module coupled to the host;
storing user data inputs and dispersion modeling outputs so that the inputs and outputs are available for retrieval and use in subsequent dispersion modeling runs.

2. The method of claim 1 wherein the user interface is a web site including web pages.

3. The method of claim 1 wherein data inputs further include facility information, building information, release parameter information, emission rates, control parameters, land use data, terrain data, meteorological data, and any combination thereof.

4. The method of claim 1 wherein executing includes compliance with the “Guidelines on Air Quality Models” as described in 40 C.F.R. 51.

5. The method of claim 1 wherein presenting comprises presenting the user interface to a plurality of users that register and maintain accounts with the host.

6. The method of claim 1 wherein executing dispersion modeling further comprises executing a plurality of dispersion modeling runs for a plurality of users, and storing further comprises storing a plurality of user data inputs and dispersion modeling outputs for the plurality of users and plurality of dispersion modeling runs.

7. The method of claim 6 further comprising queuing the plurality of dispersion modeling runs to account for limited run processing capacity.

8. The method of claim 1 wherein executing includes executing on a plurality of servers as demand for processing capacity dictates.

9. The method of claim 1 wherein executing includes executing dispersion modeling on one or more Fortran servers.

10. The method of claim 1 wherein storing includes storing on a database shared by a web server and an executable server.

11. The method of claim 1 further comprising submitting dispersion modeling jobs via an interactive job submittal tool.

12. A system comprising:
a user interface through which users may interact with a host including creating and maintaining a user account, inputting user data, and requesting dispersion modeling;
a host that maintains user data and that is coupled to a transaction module;
a storage module coupled to a transaction module, the storage module stores user data including emissions data and output modeling data related to multiple modeling runs;
a transaction module that processes user data including modeling dispersion data.

13. The system of claim 12 further comprising a Windows service that manages processing of dispersion modeling jobs.

14. The system of claim 13 wherein the Windows service polls for incoming jobs that are ready for execution, queues jobs that are ready for execution, polls for output modeling data, and updates the status of dispersion modeling jobs before, during, and after completion.

15. The system of claim 12 further comprising a plurality of executable servers in order to increase capacity for executing dispersion modeling jobs.

16. The system of claim 15 wherein the plurality of executable servers are Fortran servers.
